(19) United States
(12) Patent Application Publication
(10) Pub. No.: US 2001/0039193 A1
(43) Pub. Date: Nov. 8, 2001

(54) Sensor for detecting the state of a cover of a cellular phone

(76) Inventor: Long-Jyh Pan, Taipei Hsien (TW)

Correspondence Address: WINSTON HSU, SF. 389, FU-HO ROAD, YUNGHO CITY, TAIPEI, TW

(21) Appl. No.: 09/764,360

(22) Filed: Jan. 19, 2001

(30) Foreign Application Priority Data
May 3, 2000 (TW) 089108448

(51) Int. Cl. H04B 1/38

(52) U.S. Cl. 455/550; 455/90; 455/575

(57) ABSTRACT

A sensor for detecting whether a cover of a cellular phone is open or closed. The cellular phone includes a body with a display panel and a plurality of buttons on a front side of the body. The cover is rotatably fixed at a bottom side of the body using at least one axle. The sensor has a cam installed on the axle, and a switch installed on the body for engaging with the cam. When the cover moves to the front side of the body, the cam will engage with the switch to generate a closed signal. When the cover moves away from the front side of the body, the cam will engage with the switch to generate an open signal.

### BACKGROUND OF THE INVENTION

1. Field of Invention

The present invention provides a sensor and, more particularly, a sensor that detects whether a cover of a cellular phone is open or closed.

2. Description of the Prior Art

Many cellular phones are designed to have a cover for protecting the buttons and the panel from pollution of dusts when it is not in use. Usual covers are designed to be sheet covers, rotatably or slidably fixed onto the bottom of the cellular phone body. Therefore, the cover is also termed the flip. When the user wants to make a phone call or receive a phone call, he has to first open the flip and then starts the conversation by pressing another switch. When the user finishes the conversation, he has to press the switch again to terminate the conversation function and then close the flip. Too many operating steps will cause inconvenience to the user. To skip the step of turning on and off another switch, it is advantageous if a sensor can be provided on the cellular phone body to detect whether the flip is open or closed and to send a signal to notify the cellular phone to automatically turn on and off the conversation function.

### SUMMARY OF THE INVENTION

Therefore, it is a primary object of the present invention to provide a sensor to detect whether the cover of a cellular phone is open or closed to solve the above-mentioned problem.

According to the claimed invention, the present invention provides a sensor for detecting whether a cover of a cellular phone is open or closed. The cellular phone includes a body with a display panel and a plurality of buttons on a front side of the body. The cover is rotatably fixed at a bottom side of the body using at least one axle. The sensor has a cam installed on the axle, and a switch installed on the body for engaging with the cam. The cam will engage with the switch to generate a closed or open signal when the cover moves to the front side of the body or moves away from the front side of the body.

It is an advantage of the present invention that the sensor will send a signal to notify the cellular phone to automatically turn on or off the conversation function when the cover is moved away from or moved to the front side of the body of the cellular phone.

These and other objectives and advantages of the present invention will no doubt become obvious to those of ordinary skill in the art after having read the following detailed description of the preferred embodiment that is illustrated in the various figures and drawings.

### BRIEF DESCRIPTION OF THE DRAWINGS

FIG. 1 is an exploded diagram showing components of a cellular phone in a first embodiment of the present invention.

FIG. 2 is a perspective view of the switch in FIG. 1.

FIG. 3 is a perspective view of the trigger in FIG. 1.

FIGS. 4 and 5 are schematic views of the interaction between the trigger and the switch in FIG. 1.

### DETAILED DESCRIPTION OF THE INVENTION

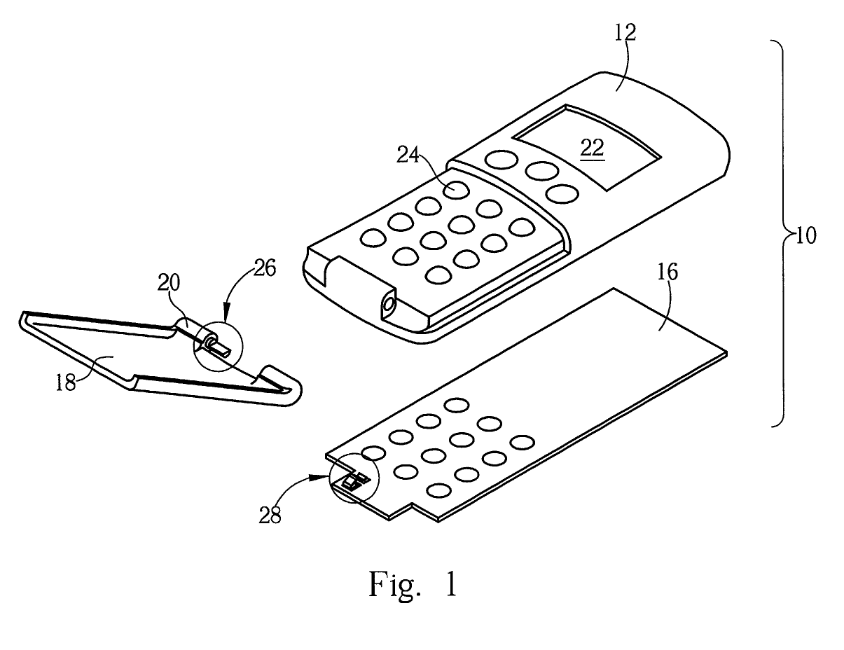

Please refer to FIG. 1. FIG. 1 is an exploded diagram showing components of a cellular phone 10 in a first embodiment of the present invention. The present invention provides a sensor for detecting whether a cover 18 of a cellular phone 10 is open or closed. The cellular phone 10 comprises a body 12, a display panel 22 and a plurality of buttons 24 on a front side of the body 12, a printed circuit board (PCB) 16 in the body 12 and a cover 18 rotatably fixed at the bottom of the body 12 through at least one axle 20. The sensor comprises a trigger 26 fixed on the axle 20 and a switch 28 installed on the PCB 16, through the interaction of which an open or close signal can be generated.

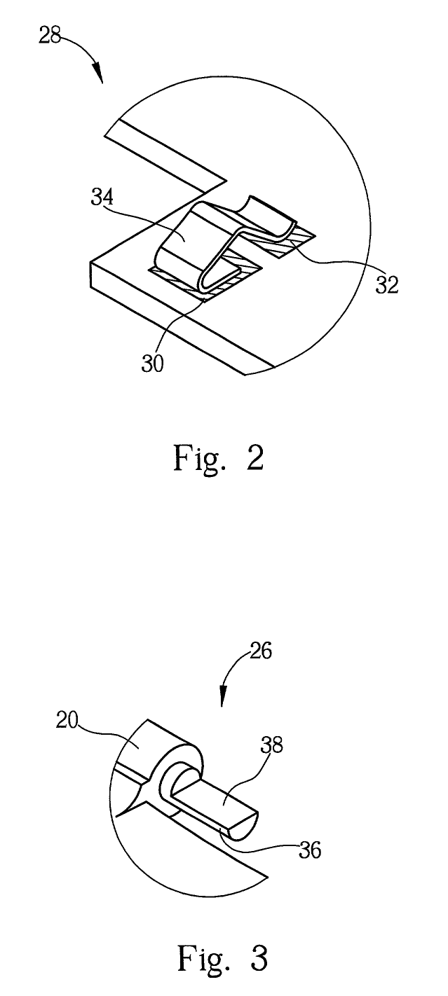

Please refer to FIGS. 2 and 3. FIG. 2 is a perspective view of the switch 28. FIG. 3 is a perspective view of the trigger 26. In the first embodiment, the switch 28 comprises a first electrode 30, a second electrode 32 and an elastic element 34. One end of the elastic element 34 is mounted on the first electrode30, the middle portion of the elastic element 34 is irregularly bumped up, and the other end of the elastic element 34 is above the second electrode 32. The trigger 26 is a cam comprising a downward-intruding surface 36 and a plane 38 and positioned above the middle portion of the elastic element 34.

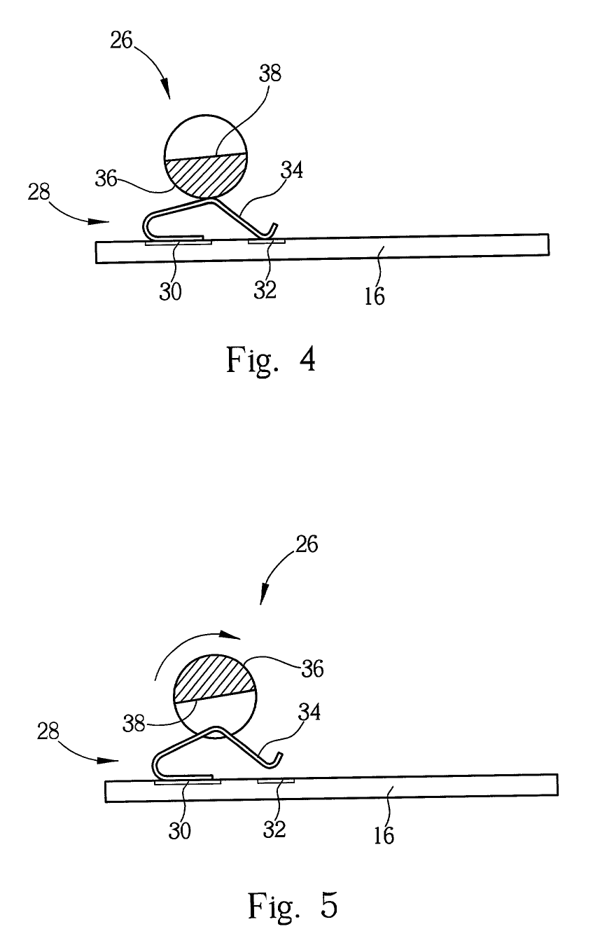

Please refer to FIGS. 4 and 5. FIGS. 4 and 5 are schematic views of the interaction between the trigger 26 and the switch 28 in FIG. 1. As shown in FIG. 4, when the cover 18 is moved away from the body 12 and some of the buttons become exposed, the intruding surface 36 of the trigger 26 will depress the middle portion of the elastic element 34 so that one end of the elastic element 34 touches the second electrode 32, electrically connecting the first and second electrodes 30,32 to generate a first signal. In the current embodiment, the first signal represents an open signal meaning that the cover 18 is detected to be open and the cellular phone 10 is notified to automatically start the conversation function. As shown in FIG. 5, when the cover 18 is moved to the body 12 and covers some of the buttons, the intruding surface 36 of the trigger 26 leaves the middle portion of the elastic element 34 and one end of the elastic element 34 departs from the second electrode 32, electrically disconnecting the first and second electrodes 30,32 to generate a second signal. In this embodiment, the second signal represents a closed signal meaning that the cover 18 is detected to be closed and the cellularphone 10 is notifiedto automatically finish the conversation function.

In addition, by the circuit design on the circuit board 16 of the cellular phone 10 and different forms of accompanying triggers 26, the electrical connection over the first and second electrodes 30,32 can be set to provide an open or closed signal. In a second embodiment, the intruding surface 36 of the trigger 26 is upside down from the first embodiment; and the first signal generated due to the electrical connection between the first and second electrodes 30,32 is a closed signal, whereas the second signal generated due to the departure of the elastic element 34 from the second electrode 32 is an open signal. In the second embodiment, when the cover 18 is shifted to the body 12, the intruding surface 36 of the trigger 26 will depress the middle portion of the elastic element 34, and thus one end of the elastic element 34 gets in contact with the second electrode 32, electrically connecting the first and second electrodes 30,32 to generate the first signal, as shown in FIG. 4. This means that the cover 18 is detected to be closed and the cellular phone 10 is notified to automatically shut down the conversation function. When the cover 18 is moved away from the body 12, the intruding surface 36 of the trigger 26 departs from the middle portion of the elastic element 34, departing one end of the elastic element 34 from the second electrode 32 and electrically disconnecting the first and second electrodes 30,32 to generate the second signal, as shown in FIG. 5. This means that the cover 18 is detected to be open and the cellular phone 10 is notified to automatically turn on the conversation function.

Aside from rotatably fixing the cover 18 onto the cellular phone 10, the cover 18 can be installed in a slidable manner.

In a third embodiment of the present invention, the cellular phone comprises a body provided with a plurality of buttons and a cover slidable between a first position and a second position. When the cover slides to the first position, it can cover at least some of the buttons. When the cover slides to the second position, at least some of the buttons become exposed. The sensor in the third embodiment comprises a trigger and a switch. The trigger is installed on the cover and includes a cam. The switch comprises two electrodes and an elastic element installed above the two electrodes. When the cover slides to the first position, the cam depresses the elastic element downward so as to electrically connect the two electrodes. When the cover slides to the second position, the cam moves away from the elastic element and the elastic element separates from at least one of the two electrodes so as to electrically disconnect the two electrodes.

In an analogous method, a fourth embodiment of the present invention is as follows: the cellular phone comprises a body provided with a plurality of buttons and a cover that can slide between a first position and a second position. When the cover slides to the first position, it can cover at least some of the plurality of buttons. When the cover slides to the second position, at least some of the buttons become exposed. The sensor in the fourth embodiment comprises a trigger and a switch. The trigger is installed on the cover and includes a cam. The switch comprises two electrodes and an elastic element installed above the two electrodes. When the cover slides to the first position, the cam moves away from the elastic element and the elastic element separates from at least one of the two electrodes so as to electrically disconnect the two electrodes. When the cover slides to the second position, the cam depresses the elastic element downward so as to electrically connect the two electrodes.

Compared with the prior art, the sensor for detecting whether the cover 18 of the cellular phone 10 is open or closed makes use of the interaction between the trigger 26 and the switch 28 during the opening and closing processes of the cover 18 to generate an open or closed signal, thus notifying the cellular phone 10 to automatically start or finish the conversation function.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A sensor for detecting whether a cover of a cellular phone is open or closed, the cellular phone comprising a body with a display panel and a plurality of buttons on a front side of the body, the cover being rotatably fixed at a bottom side of the body using at least one axle, the sensor comprising:
a trigger installed on the axle; and
a switch installed on the body for engaging with the trigger;
wherein when the cover moves to the front side of the body, the trigger and the switch will engage to generate a closed signal, and when the cover moves away from the front side of the body, the trigger and the switch will engage to generate an open signal.

2. The sensor of claim 1 wherein the trigger is a cam installed on the axle, the cam depressing the switch to make the switch generate the open signal or the closed signal.

3. The sensor of claim 2 wherein the switch comprises two electrodes and an elastic element positioned above the two electrodes; wherein when the cam depresses the elastic element, the elastic element will electrically connect the two electrodes, and when the cam leaves the elastic element, the elastic element will separate from at least one of the two electrodes so as to electrically disconnect the two electrodes, and whether the two electrodes are electrically connected determines whether the open signal or the closed signal is generated.

4. The sensor of claim 1 wherein the cover is used for covering the plurality of buttons on the front side of the body.

5. A sensor for detecting whether a cover of a cellular phone is open or closed, the cellular phone comprising a body with a plurality of buttons, the cover being slidable between a first position and a second position, the cover covering at least a portion of the plurality of buttons when in the first position and exposing at least a portion of the plurality of buttons when in the second position, the sensor comprising:
a trigger installed on the cover; and
a switch installed on the body for engaging with the trigger;
wherein the trigger and the switch will engage to generate a closed signal when the cover slides to the first position, the trigger and the switch will engage to generate an open signal when the cover slides to the second position.

6. The sensor of claim 5 wherein the trigger comprises a cam which depresses the switch to make the switch generate the open or closed signal.

7. The sensor of claim 6, wherein the switch comprises two electrodes and an elastic element positioned above the two electrodes, when the cover is at the first position the cam will depress the elastic element to electrically connect the two electrodes, when the cover is at the second position the cam will make the elastic element separate from at least one electrode of the two electrodes so as to electrically disconnect the two electrodes.

8. The sensor of claim 6, wherein the switch comprises two electrodes and an elastic element positioned above the two electrodes, when the cover is at the first position the cam will make the elastic element separate from at least one electrode of the two electrodes so as to electrically disconnect the two electrodes, when the cover is at the second position the cam will depress the elastic element to electrically connect the two electrodes.
